(19) United States
(12) Patent Application Publication
(10) Pub. No.: US 2018/0323483 A1
(43) Pub. Date: Nov. 8, 2018

(54) INTELLIGENT APPARATUS SYSTEM FOR BATTERY THERMAL INSULATION AND PROTECTION

(71) Applicant: CHUNG-YEH HSU, (US)

(72) Inventors: CHUNG-YEH HSU, NEW TAIPEI CITY (TW); RICHARD CHI-HSUEH, SAN DIEGO, CA (US)

(21) Appl. No.: 15/916,414

(22) Filed: Mar. 9, 2018

Related U.S. Application Data
(60) Provisional application No. 62/501,364, filed on May 4, 2017.

(51) Int. Cl. H01M 10/6571; H01M 10/658; H01M 2/10; H01M 10/615; H01M 10/625

(52) U.S. Cl. CPC H01M 10/6571; H01M 10/658; H01M 10/625; H01M 10/615; H01M 2/1094

(57) ABSTRACT

An intelligent apparatus system for battery thermal insulation and protection is disclosed. It comprises a heating fabric cloth having plural conductive yarns arranged in a first direction, plural textile yarns and plural metal conductive wires arranged in a second direction for wrapping a battery assembly for temperature maintenance; a power supply electrically connected to the heating fabric cloth; and a temperature controlling circuit electrically connected to the heating fabric cloth and the power supply. Each of the plural conductive yarns comprises a plurality of filaments and an electric heating wire winding around the plurality of filaments.

### CROSS REFERENCE TO RELATED APPLICATION

This application claims the benefits from U.S. Provisional Application No. 62/501,364, filed on May 4, 2017, currently pending, the subject matter of which is incorporated herein by reference.

### BACKGROUND OF THE INVENTION

### 1. Field of the Invention

The present invention relates to an intelligent apparatus system for battery thermal insulation and protection which maintains a normal operation of a battery assembly under a low-temperature working environment.

### 2. Description of Related Art

In modern society, various electronics are ubiquitous in daily life including 3C products, personal computer, communication and consumer electronics, and electric transportation devices. To improve convenience in using electronics, techniques for saving electric power in batteries have been developed so that the electronics installed with a battery, e.g. wireless vacuum cleaner, mobile phone, and laptop, can be operated while they are not connected to a socket. Vehicles using petrol or diesel as an energy source are considered to cause severe environmental pollution. For example, exhaust gas emitted by an engine leads to air pollution, and noise made by an engine result in noise pollution. Since the conception of environment protection has been noted, the petrol cars or the diesel cars have been replaced with electric cars which do not produce exhaust gas and noise.

Battery life is an important indicator to evaluate a battery, so how to improve battery life has always been an important topic of research and development. Besides characteristics a battery itself equipped, the working environment also affects the operation of the battery, including battery life and power output. An internal temperature of the battery is hard to increase under a low-temperature working environment, resulting in easy loss of electric power, thereby lacking electricity and affecting the battery life. Furthermore, lithium ions in a lithium battery used in computer, communication and consumer electronics have increased resistance at low temperatures when transferred between a cathode and an anode, which triggers premature cut-off voltage, lowers discharge capacity, and reduces lifetime of the lithium battery.

### SUMMARY OF THE INVENTION

The present invention relates to an intelligent apparatus system for battery thermal insulation and protection, which has a heating apparatus to increase a working temperature of a battery assembly above 0° C. or above an average operational temperature and make the battery assembly charge or dischare normally, so as to improve the performance of the battery assemblies of 3C product under a low-temperature working environment.

The intelligent apparatus system for battery thermal insulation and protection of the present invention comprises a heating fabric cloth, a power supply and a temperature controlling circuit. The heating fabric cloth has plural conductive yarns arranged in a first direction plural textile yarns and plural metal conductive wires arranged in a second direction. Each of the plural conductive yarns comprises a plurality of filaments and an electric heating wire winding around the plurality of filaments. The power supply is electrically connected to the heating fabric cloth, and the temperature controlling circuit is electrically connected to the heating fabric cloth and the power supply.

According to an embodiment of the present invention, the plural metal conductive wires are fine copper wires or fine silver wires, aligned at two sides of the heating fabric cloth to form two conductive sides, and connected to the plural conductive yarns to form an electric circuit. The plural textile yarns are aligned between the two conductive sides.

According to an embodiment of the present invention, the plural metal conductive wires are connected to the temperature controlling circuit by a connection wire.

According to an embodiment of the present invention, the temperature controlling circuit is an automatic controlling circuit or a manual controlling circuit.

According to an embodiment of the present invention, a bag structure is made of the heating fabric cloth for accommodating a battery assembly of different sizes or different types.

According to an embodiment of the present invention, the plural metal conductive wires are electrically connected to the power supply.

According to an embodiment of the present invention, the temperature controlling circuit is an intelligent temperature controlling circuit to turn on or turn off the power supply.

Accordingly, the power supply of the present invention provides electric energy for heating the heating fabric cloth. Thus, a battery assembly encapsulated by the heating fabric cloth will not discharge abnormally under a low-temperature working environment.

### BRIEF DESCRIPTION OF THE DRAWINGS

FIG. 1 is a stereogram showing an intelligent apparatus system for battery thermal insulation and protection of the present invention;

FIG. 2 is a stereogram showing a textile pattern of a heating fabric cloth of the present invention;

FIG. 3 is a schematic diagram showing a textile pattern of a heating fabric cloth of the present invention;

FIG. 4 is a perspective stereogram showing a thermal insulation box constructed in accordance with the present invention;

FIG. 5 is a schematic diagram showing an intelligent apparatus system of the present invention used in an electric car for battery thermal insulation and protection.

### DETAILED DESCRIPTION OF THE PREFERRED EMBODIMENT

To provide a thorough understanding, the purpose and advantages of the present invention will be described in detail with reference to the accompanying drawings.

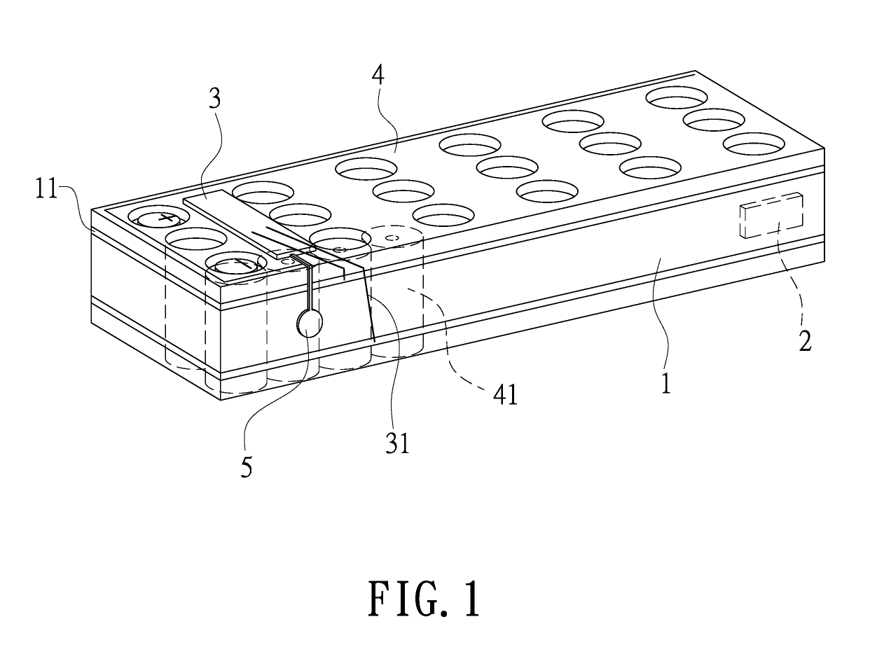

Referring to FIG. 1, an intelligent apparatus system for battery thermal insulation and protection of the present invention comprises a heating fabric cloth (1), a power supply (2) and a temperature controlling circuit (3). The heating fabric cloth (1) is electrically connected to the power supply (2) and the temperature controlling circuit (3). A battery assembly (4) is encapsulated by the heating fabric cloth (1), and the battery assembly (4) may comprise plural batteries (41) connected in series or in parallel. Two conductive sides (11) having plural metal conductive wires are aligned at two sides of the heating fabric cloth (1) and connected to the temperature controlling circuit (3) by a connection wire (31). A temperature detection element (5) is further provided and connected to the temperature controlling circuit (3) to detect an environmental temperature and reports it to the temperature controlling circuit (3).

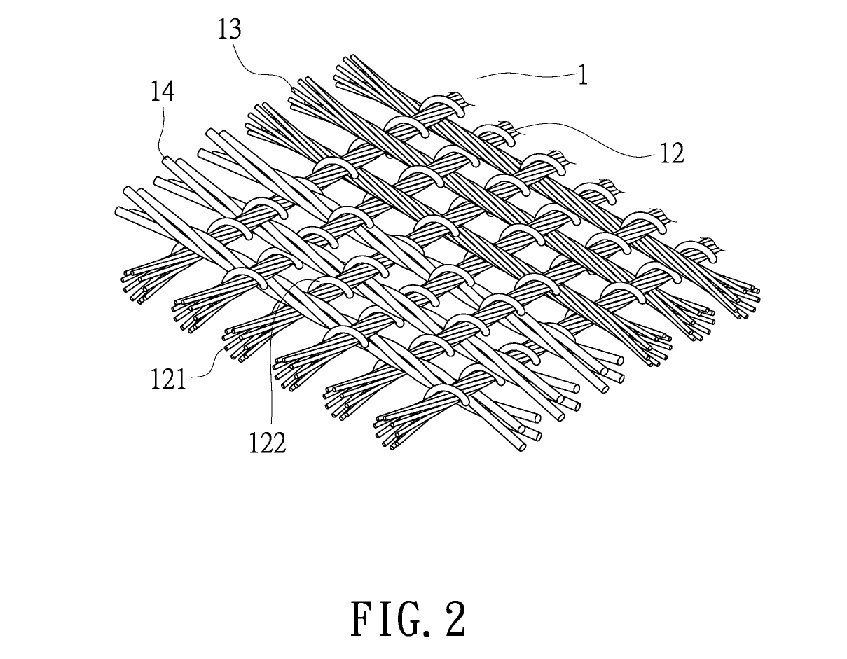

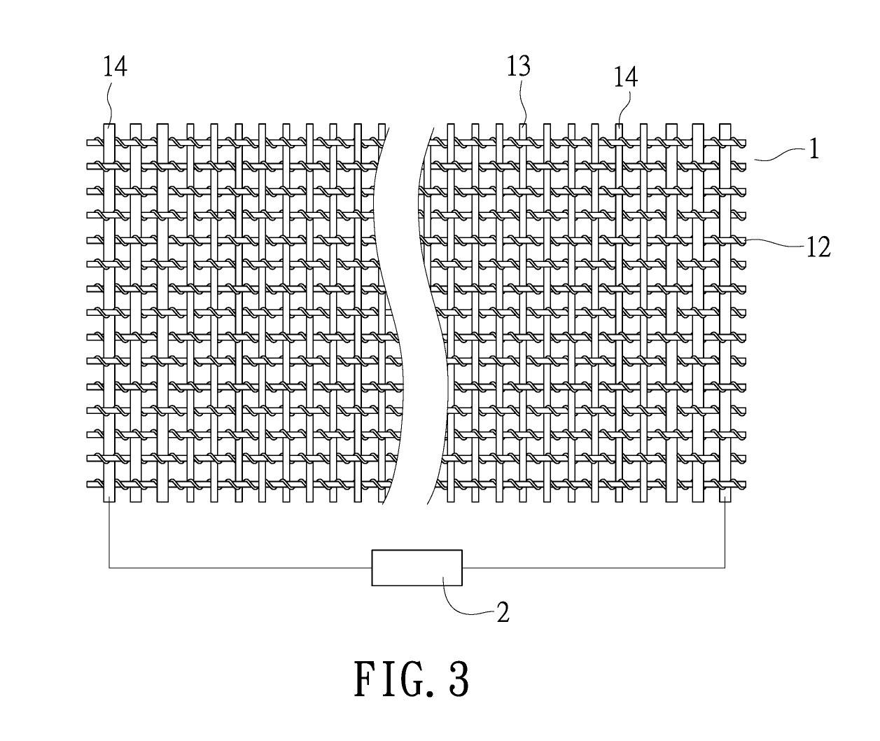

Please referring to FIG. 2 and FIG. 3, the heating fabric cloth (1) comprises plural conductive yarns (12) arranged in a first direction and plural textile yarns (13) and plural metal conductive wires (14) arranged in a second direction. The heating fabric cloth (1) is formed by interweaving the conductive yarns (12) with the textile yarns (13) and the metal conductive wires (14). The plural metal conductive wires (14) are fine copper wires or fine silver wires, and aligned at two sides of the heating fabric cloth (1) to form the two conductive sides (11). The plural textile yarns (13) are aligned in a middle region of the heating fabric cloth (1) and between the two conductive sides (11). Each of the plural conductive yarns (12) comprises a plurality of filaments (121) and an electric heating wire (122) winding around the plurality of filaments (121). The textile yarns (13) are ordinary yarns used in textile industry. The conductive yarns (12) are connected to the metal conductive wires (14) to form an electric circuit.

Please referring to FIG. 1 and FIG. 3, the power supply (2) of this invention provides a voltage ranging from 0 to 48 V, and the voltage, current or temperature exported from the power supply (2) are adjusted by the temperature controlling circuit (3). The electric circuit constructed by the conductive yarns (12) and the metal conductive wires (14) in the heating fabric cloth (1) is heated up to a required temperature ranging from 0 to 85° C. after a current passes through. After the temperature of the heating fabric cloth (1) reaches a predetermined temperature, the working temperature of the battery assembly (4) encapsulated by the heating fabric cloth (1) can be maintained to make the battery assembly (4) charge or discharge normally so as to improve deficiencies of abnormally operation under a low-temperature working environment and enhance the performance of the battery assembly (4) including battery life and power output. The battery assembly (4) mentioned in the present invention includes but not limits to a battery assembly of electric vehicles or a battery assembly of 3C products. The electric vehicles mentioned above include but not limit to electric cars, electric motorcycles, electric bicycles or electric wheelchairs. The 3C products include but not limit to mobile phones, cameras, laptops and tablets computers.

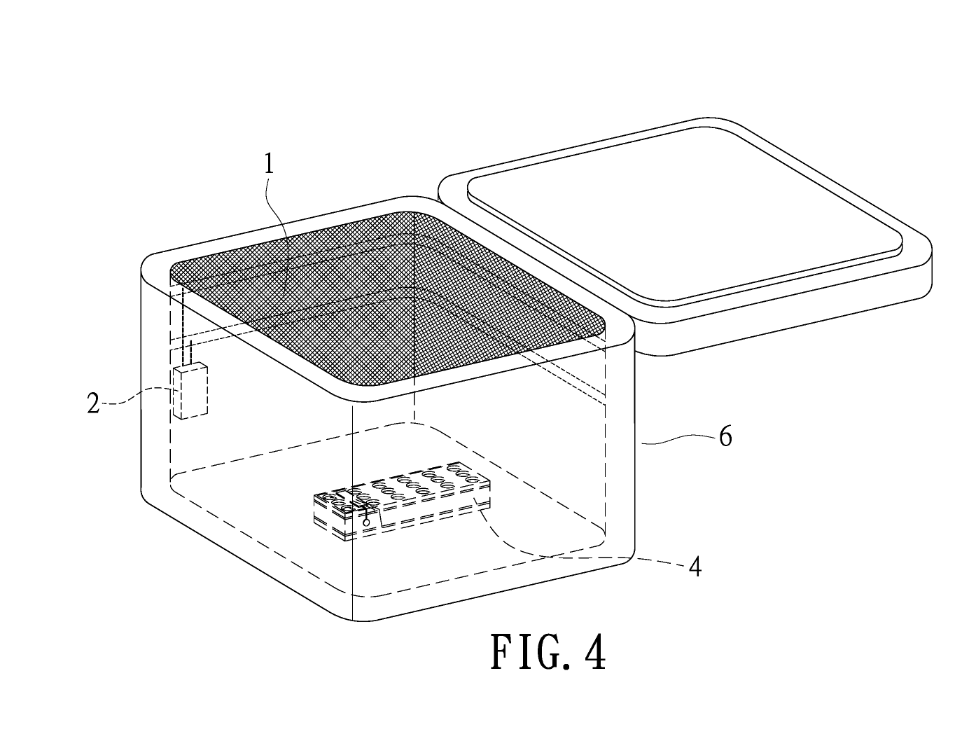

Referring to FIG. 4, the heating fabric cloth (1) of the present invention can be applied to manufacture a battery thermal insulation case or a battery thermal insulation box (6) directly as an internal lining material. The heating fabric cloth (1) is lined inside the battery thermal insulation box (6) and connected to the power supply (2) for obtaining electricity, and the battery assembly (4) to be protected is placed into the battery thermal insulation box (6). When the environmental temperature decreases, the heating fabric cloth (1) is electrified and heated up to protect the battery assembly (4) and make it work normally. In addition, the battery thermal insulation box (6) is made of low thermal conductive materials to prevent quickly heat loss.

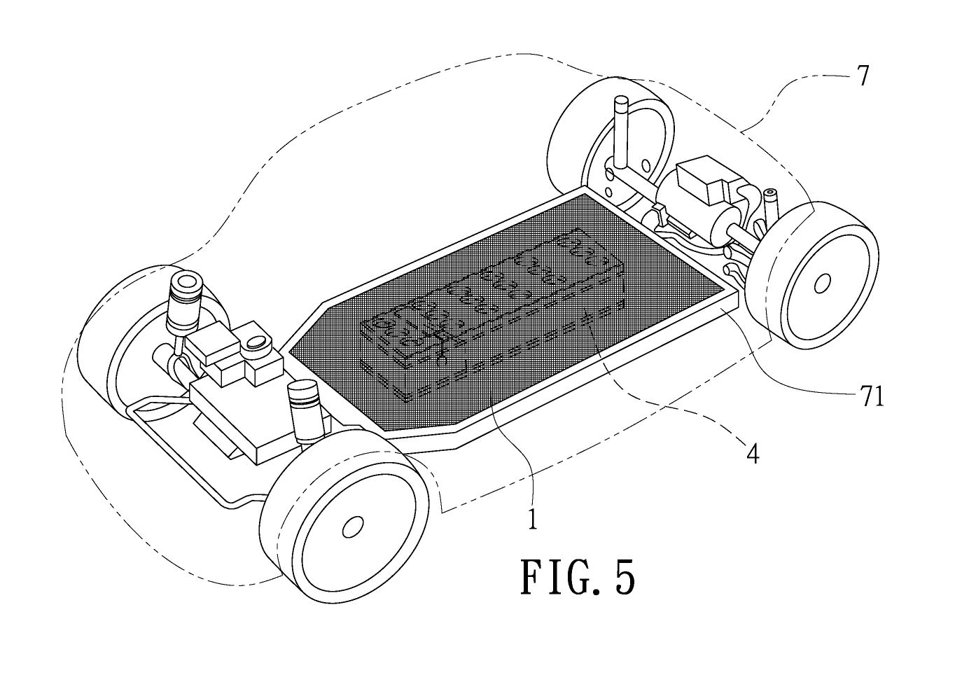

Referring to FIG. 5, the heating fabric cloth (1) of the present invention can be applied to maintain temperature of a battery of an electric car (7). As shown in FIG. 5, the battery assembly (4) is installed on a floor plate (71) of the electric car (7), and the floor plate (71) is encapsulated by the heating fabric cloth (1). When the environmental temperature decreases, the heating fabric cloth (1) is electrified and heated up to maintain temperature of the battery assembly (4).

The heating fabric cloth of the present invention is processed by weaving and has plural breathable micro holes as an ordinary textile cloth so as to emit heat from the encapsulated battery assembly. Thus the intelligent apparatus system for battery thermal insulation and protection of the present invention does not interfere heat dissipation of the battery assembly.

The temperature controlling circuit of the present invention is an automatic controlling circuit or a manual controlling circuit. After the battery assembly is wrapped in the heating fabric cloth, the power supply can be turned on or turned off automatically or manually by the temperature controlling circuit for heating or cooling the heating fabric cloth.

Furthermore, a bag structure is made of the heating fabric cloth for accommodating a battery assembly to be protected of different sizes or different types. When a low environmental temperature is detected by the temperature detection element of the present invention, the power supply can be turned on by the temperature controlling circuit and then the heating fabric cloth is electrified and heated up to maintain a safety temperature for preserving the battery assembly inside the bag.

In another embodiment, the heating fabric cloth is integrated into an outer casing of the battery assembly as a complete piece during the manufacturing process thereof. The temperature detection element and the temperature controlling circuit are further integrated to a controlling circuit of the battery assembly, and the battery assembly can protect itself under a low temperature environment.

The heating fabric cloth of this invention can be tailored for assembling to other heating fabric cloths in use.

In the present invention, battery mentioned above includes but not limits to lead battery, nickel-cadmium battery, nickel-iron battery, nickel-metal hydride battery (e.g. low self-discharge nickel-metal hydride battery), nickel-lithium battery, nickel-zinc battery, lithium air battery, lithium-ion battery, lithium polymer battery, lithium iron phosphate battery, lithium-titanate battery, lithium-sulfur battery, nanowire battery, potassium-ion battery, sodium-ion battery, vanadium redox battery, zinc-cerium battery, aluminum-ion battery, fuel battery and the like.

According to the above description and embodiments, the present invention has the advantages as following:

1. The intelligent apparatus system for battery thermal insulation and protection of the present invention comprises a heating fabric cloth which has warming effects to maintain a working temperature of a battery assembly, and the plural breathable micro holes in the heating fabric cloth provide a well heat dissipation effect.

2. The heating fabric cloth of the present invention is formed by interweaving plural conductive yarns winding by the electric heating wire with plural textile yarns and metal conductive wires, in which the plural conductive yarns are distributed evenly and connected to the metal conductive wires to form an electric circuit. When the power supply is turned on, the electric circuit is electrified and the conductive yarns along with the metal conductive wires are heated to elevate the temperature of the heating fabric cloth evenly.

3. Each of the conductive yarns of the heating fabric cloth in the present invention comprises a plurality of filaments and an electric heating wire spirally winding around the plurality of filaments, which provides a reserved space for thermal expansion or contraction of the electric heating wire after the heating fabric cloth is electrified or un-electrified. Furthermore, the spirally winding electric heating wire is flexible and not ripped apart easily, so the heating fabric cloth can be folded or extended conveniently.

What is claimed is:

1. An intelligent apparatus system for battery thermal insulation and protection, comprising:
a heating fabric cloth having plural conductive yarns arranged in a first direction and plural textile yarns and plural metal conductive wires arranged in a second direction, wherein each of the plural conductive yarns comprises a plurality of filaments and an electric heating wire winding around the plurality of filaments;
a power supply electrically connected to the heating fabric cloth; and
a temperature controlling circuit electrically connected to the heating fabric cloth and the power supply.

2. As the intelligent apparatus system for battery thermal insulation and protection claimed in claim 1, wherein the plural metal conductive wires are fine copper wires or fine silver wires, aligned at two sides of the heating fabric cloth to form two conductive sides, and connected to the plural conductive yarns to form an electric circuit, and wherein the plural textile yarns are aligned between the two conductive sides.

3. As the intelligent apparatus system for battery thermal insulation and protection claimed in claim 2, wherein the plural metal conductive wires are connected to the temperature controlling circuit by a connection wire.

4. As the intelligent apparatus system for battery thermal insulation and protection claimed in claim 1, wherein the temperature controlling circuit is an automatic controlling circuit or a manual controlling circuit.

5. As the intelligent apparatus system for battery thermal insulation and protection claimed in claim 1, wherein a bag structure is made of the heating fabric cloth for accommodating a battery assembly of different sizes or different types.

6. As the intelligent apparatus system for battery thermal insulation and protection claimed in claim 1, wherein the plural metal conductive wires are electrically connected to the power supply.

7. As the intelligent apparatus system for battery thermal insulation and protection claimed in claim 4, wherein the temperature controlling circuit is an intelligent temperature controlling circuit to turn on or turn off the power supply.

8. As the intelligent apparatus system for battery thermal insulation and protection claimed in claim 5, wherein the temperature controlling circuit is an intelligent temperature controlling circuit to turn on or turn off the power supply.
